(19) United States
(12) Patent Application Publication
(10) Pub. No.: US 2006/0289217 A1
(43) Pub. Date: Dec. 28, 2006

(54) Drive train for a motor vehicle

(75) Inventors: Dag-Arnulf Schlaf, Gifhorn (DE); Volker Jacob, Obernholz (DE); Michael Engel, Gifhorn (DE); Thomas Lomker, Gifhorn (DE)

Correspondence Address: LERNER GREENBERG STEMER LLP, P O BOX 2480, HOLLYWOOD, FL, 33022-2480, US

(73) Assignee: Volkswagen AG

(21) Appl. No.: 11/474,213

(22) Filed: Jun. 23, 2006

(30) Foreign Application Priority Data
Jun. 23, 2005 (DE) 10 2005 029 112.0

(51) Int. Cl. B60K 23/08

(52) U.S. Cl. 180/247

(57) ABSTRACT

A drive train for a motor vehicle has a drive unit arranged longitudinally at the front of the vehicle. The drive unit includes a driving engine and a transmission, the input shaft of which is connected via a starting element to the drive shaft of the driving engine, and the output shaft of which is connected for the purpose of providing a drive to a rear drive train of a drivable rear axle and/or to a front drive train of a drivable front axle, has a front output drive, i.e., power takeoff, from the transmission for the connection of the front drive train, which is arranged at the front end of the output shaft adjacent to the engine and is provided with an output drive connection lying laterally next to the transmission and oriented towards the front, and a rear output drive from the transmission for the connection of the rear drive train, which is arranged at the rear end of the output shaft remote from the engine and is provided with an output drive connection lying centrically at the end of the transmission and oriented towards the rear.

### BACKGROUND OF THE INVENTION

Field of the Invention

The invention relates to a drive train for a motor vehicle having a drive unit arranged longitudinally at the front of the vehicle consisting of a driving or propulsion engine and a transmission, the input shaft of which is connected via a starting element to the drive shaft of the driving engine, and the output shaft of which is connected for the purpose of providing a drive to a rear drive train of a drivable rear axle and/or to a front drive train of a drivable front axle.

The driving engine is preferably an internal combustion piston engine, the drive shaft of which is constituted by the crankshaft. The driving engine can also be implemented differently, however, and, for example, as an electric motor or as a hybrid engine consisting of an internal combustion engine and an electric motor. The starting element can be implemented as a dry clutch, as a wet-running clutch or as a hydraulic torque converter. The transmission shall be understood to be a speed change gear mechanism, of which the transmission ratio can be varied manually and/or automatically in steps or continuously for the purpose of adapting it to different traveling speeds. In this case, the transmission can thus be a manual gearbox, an automatic gearbox, a gearbox with a double clutch, an automatic planetary gearbox, or a CVT transmission.

The drive train of all-wheel-drive motor vehicles with a drive unit arranged longitudinally is based for the most part on a relatively simple drive train for a basic design of the motor vehicle in question having only a single driven axle. This is either the front axle or the rear axle.

In most front-wheel-drive motor vehicles with a drive unit installed longitudinally at the front of the vehicle, the axle differential of the front axle is arranged directly at the front end of the output shaft of the transmission adjacent to the engine. A relatively compact drive unit admittedly results from this arrangement, and the axle differential of the front axle can be arranged within the gearbox casing of the transmission. An unfavorable feature of this, however, is the necessary arrangement of the driving engine ahead of the front axle, the disadvantageous consequence of which is a large front overhang in conjunction with a small front angle of inclination and a high axle loading on the front axle in combination with an unfavorable axle load distribution. In an all-wheel-drive embodiment of a drive train of this type, of the kind previously disclosed in German published patent applications DE 103 04 810 A1 and DE 103 18 332 A1, for example, the output shaft of the transmission is implemented as a hollow shaft and is connected on one side to a central differential arranged counter to the direction of travel behind the transmission. A first drive shaft is oriented away from the central differential towards the front and is routed centrically within the output shaft as far as the axle differential of the front axle arranged directly ahead of the transmission. A second drive shaft is oriented away from the central differential towards the rear and is routed, for example, in a transmission tunnel as far as the axle differential of the rear axle. A relatively compact drive train is admittedly achieved in this way. Nevertheless, the disadvantages attributable to the arrangement of the driving engine ahead of the front axle remain unchanged.

In most rear-wheel-drive motor vehicles with a drive unit installed longitudinally at the front of the vehicle, the output shaft from the transmission is connected to the axle differential of the rear axle via a drive shaft attached to the rear end of the output shaft remote from the engine. The driving engine can accordingly be arranged on or behind the front axle, so that a short front overhang and a relatively small axle loading on the front axle are possible. In an all-wheel-drive embodiment of a drive train of this type, of the kind previously disclosed in German published patent application DE 42 13 537 A1, in international application PCT/EP99/02716, and in German published patent application DE 101 62 337 A1, for example, the output shaft of the transmission is connected on one side directly to a central differential arranged counter to the direction of travel behind the transmission. A first drive shaft is oriented from the central differential towards the rear and is routed, for example, in a transmission tunnel as far as the axle differential of the rear axle. A second drive shaft is routed from the central differential laterally next to the transmission and the driving engine towards the front as far as the axle differential of the front axle. An associated disadvantage is the need for a large installation space alongside the drive unit, which in the case of the corresponding all-wheel-drive versions calls for significant modifications to the underbody, in particular widening of the transmission tunnel in conjunction with narrowing of the interior space of the vehicle.

In addition, both of the previously disclosed drive train configurations exhibit the disadvantage that the other basic drive in each case, i.e. a pure rear-wheel drive in the case of the front-wheel drive-based drive train, and a pure front-wheel drive in the case of the rear-wheel drive-based drive train, is not achievable at a reasonable cost and with the need for only a small installation space.

### SUMMARY OF THE INVENTION

It is accordingly an object of the invention to provide a novel drive train for a motor vehicle which overcomes the above-mentioned disadvantages of the heretofore-known devices and methods of this general type and which provides for a drive train for motor vehicles with a drive unit installed longitudinally at the front of the vehicle, which, due to its simple and space-saving construction, permits a favorable arrangement of the driving engine, and the component parts of which can be used in a modular system without the need for significant modifications in the case of motor vehicles with all-wheel drive, rear-wheel drive, and front-wheel drive.

With the foregoing and other objects in view there is provided, in accordance with the invention, a drive train for a motor vehicle having a front axle and a rear axle, comprising:

a drive unit disposed longitudinally at a front of the vehicle and including a driving engine and a transmission;

the transmission having an input shaft connectible to a drive shaft of the driving engine and an output shaft connected for selectively driving a rear drive train of the rear axle and/or a front drive train of the front axle;

the transmission having a front power takeoff disposed for connection of the front drive train to a front end of the output shaft and for connection of a power takeoff connection laterally adjacent the transmission and oriented forward towards the front, and the transmission having a rear power takeoff disposed for connection of the rear drive train to a rear end of the output shaft remote from the engine and for connection of a power takeoff connection lying centrically at an end of the transmission and oriented towards the rear.

In other words, the objects of the invention are achieved with an assembly that has a front output drive from the transmission arranged for the connection of the front drive train to the front end of the output shaft adjacent to the engine and that is provided with an output drive connection lying laterally next to the transmission and oriented towards the front. Furthermore, a rear power takeoff from the transmission is arranged for the connection of the rear drive train to the rear end of the output shaft remote from the engine and is provided with a power takeoff connection lying centrically at the end of the transmission and oriented towards the rear.

As described in greater detail below with reference to a number of illustrative embodiments, the design of the transmission with the laterally arranged front power takeoff and the centrically arranged rear power takeoff provides the possibility to create a drive train with all-wheel drive, rear-wheel drive and front-wheel drive with simple and space-saving components, in conjunction with which the longitudinally arranged drive unit can be arranged at will at the front of the vehicle. Henceforth, it is possible to arrange the driving motor on or behind the front axle in order to achieve a short front overhang and a balanced distribution of the axle loading, regardless of the type of drive. Because a drive shaft is no longer arranged laterally adjacent to the transmission, the packaging problems customarily associated with motor vehicles with rear-wheel drive-based all-wheel-drive are no longer encountered. An arrangement of the driving engine ahead of the front axle is possible, even if this does not appear to be sensible for the aforementioned reasons. In the case of all-wheel-drive embodiments of the drive train, a drive coupling is required in only one of the two drive trains, by means of which, instead of a central differential, variations in speed between the front axle and the rear axle can be equalized, and the power distribution between the driving axles can be variably adjusted. The drive coupling used for this purpose can be passive in its effect, i.e. it can be executed so that it is capable of automatic control and, for example, embodied as a Visco coupling or a Haldex coupling. The drive coupling can also be executed, however, so that it is capable of active control and embodied for the control of the transmitted torque in accordance with various operating parameters, for example as a multi-plate clutch capable of being operated by a hydraulic, pneumatic, electromagnetic or electromotive actuating drive.

In accordance with an added feature of the invention, the front power takeoff from the transmission is an output gearbox with an internal power takeoff wheel disposed within the transmission and mounted rigidly and non-rotatably on the output shaft, and an external power takeoff wheel outside the transmission mounted rotatably about an axis parallel to the output shaft in a power takeoff casing, the external power takeoff wheel projecting through an opening in the transmission and meshing with the inner power takeoff wheel.

Whereas the rear power takeoff from the output shaft for the connection of the rear drive train can correspond to that of a rear-wheel-drive vehicle in a previously disclosed fashion, the front power takeoff from the output shaft for the connection of the front drive train is preferably in the form of an output gearbox, which includes an internal power takeoff wheel within the transmission arranged rigidly on the output shaft so that it is incapable of rotation, and an external power takeoff wheel outside the transmission and parallel to the axis rotatably mounted in a power takeoff casing and in toothed engagement with the inner power takeoff wheel extending through an opening in the transmission. The internal power takeoff wheel can be a toothed wheel provided specially for this purpose. It is also possible, however, to utilize a gear wheel already arranged on the output shaft of the transmission as a fixed wheel for this purpose.

The component parts of the drive train in accordance with the invention can be used for the achievement of an all-wheel drive system with engageable front-wheel drive, in that the rear axle is connected permanently via the rear drive train to the output shaft of the transmission, and the front axle is connected in a variably engageable fashion via a controllable drive coupling arranged within the front drive train to the output shaft of the transmission. The drive coupling in this case can be arranged as close as desired to the front power takeoff from the output shaft, for example on the power takeoff housing, or on the axle differential of the front axle.

In a pure rear-wheel-drive embodiment, on the other hand, only the rear drive train with a permanent connection of the output shaft of the transmission to the rear axle is present, i.e. without a drive coupling, and the opening in the transmission on the front power takeoff from the output shaft is then closed, for example, with a simple cover. If the internal power takeoff wheel of the front power takeoff is a separate toothed wheel, this can be economized on, i.e. omitted, in this embodiment.

Likewise, the component parts of the drive train in accordance with the invention can also be used to realize an all-wheel-drive system with engageable rear-wheel drive, in that the front axle is connected permanently via the front drive train to the output shaft of the transmission, and the rear axle is connected to the output shaft of the transmission in a variably engageable fashion via a controllable drive coupling arranged within the rear drive train. The drive coupling in this case can then be arranged either close to the rear power takeoff from the output shaft on the transmission or on the axle differential of the rear axle.

In a pure front-wheel-drive embodiment of the motor vehicle, on the other hand, only the front drive train with a permanent connection of the output shaft of the transmission to the front axle is present, and an opening in the transmission on the rear power takeoff from the output shaft is appropriately simply closed with a cover.

Further particulars of the invention can be appreciated from the following detailed description and the accompanying drawings, which serve to explain the invention in an exemplary fashion.

Other features which are considered as characteristic for the invention are set forth in the appended claims.

Although the invention is illustrated and described herein as embodied in a drive train for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic plan view of a first embodiment of the drive train in accordance with the invention;

FIG. 2 is a schematic plan view of a second embodiment of the drive train in accordance with the invention;

FIG. 3 is a schematic plan view of a third embodiment of the drive train in accordance with the invention;

FIG. 4 is a schematic plan view of a fourth embodiment of the drive train in accordance with the invention;

FIG. 5 is a schematic plan view of a fifth embodiment of the drive train in accordance with the invention; and

FIG. 6 is a schematic plan view of a sixth embodiment of the drive train in accordance with the invention.

### DETAILED DESCRIPTION OF PREFERRED EXEMPLARY EMBODIMENTS

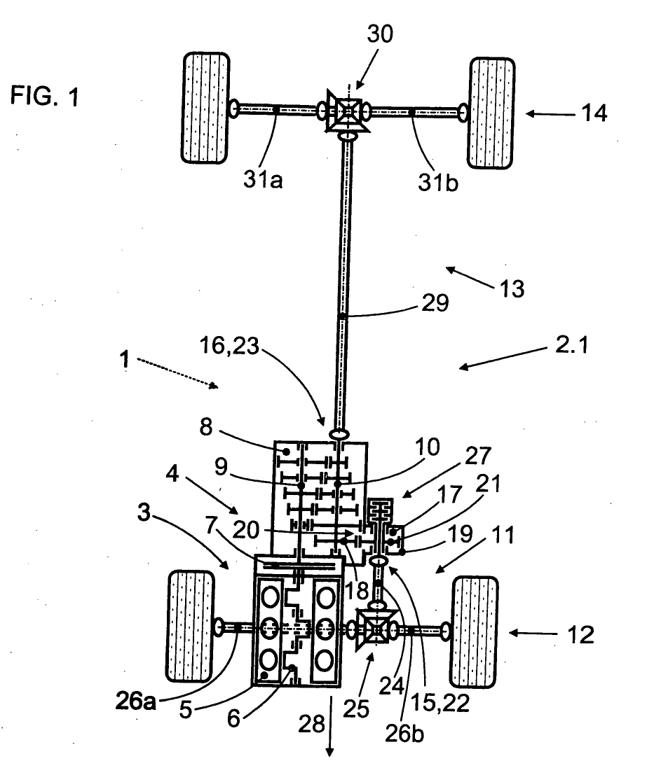

Referring now to the figures of the drawing in detail, each of the figures FIG. 1 to FIG. 6 depicts a motor vehicle 1 with a drive train 2 provided with a drive unit 4 that is arranged longitudinally at the front 3 of the vehicle. The drive unit 4 consists of a driving engine 5 and a transmission 8, the input shaft 9 of which is connected via a starting element 7 to the drive shaft 6 of the driving engine 5, and the output shaft 10 of which is connected for the purpose of providing a drive to a front drive train 11 of a drivable front axle 12 and/or to a rear drive train 13 of a drivable rear axle 14. In the present case, the driving engine 5 is executed as an internal combustion piston engine in V6 configuration having a crankshaft as a drive shaft 6, the starting element 7 is executed as a separating coupling, and the transmission 8 is executed as a manual transmission with five ratios by way of example, i.e. without any restrictive commitment to a particular arrangement.

In a first embodiment according to FIG. 1, the drive train 2.1 in accordance with the invention implements all-wheel drive with permanent rear-wheel drive and engageable front-wheel drive. A front output or power takeoff 15 for the connection of the front drive train 11 to the front axle 12 is provided for this purpose at the front end of the output shaft 10 adjacent to the engine, and a rear output or power takeoff 16 for the connection of the rear drive train 13 to the rear axle 14 is provided for this purpose at the rear end of the output shaft 10 remote from the engine. The front power takeoff 15 from the output shaft 10 is formed in the present case by an output gearbox 17, which exhibits an internal power takeoff wheel 18 within the transmission 8 arranged rigidly on the output shaft 10 so that it is incapable of rotation, and an external power takeoff wheel 21 outside the transmission 8 parallel to the axis and rotatably mounted in a power takeoff casing 19 and in toothed engagement with the inner power takeoff wheel 18 extending through an opening 20 in the transmission 8, in conjunction with which a power takeoff connection 22 lying laterally next to the transmission 8 and oriented towards the front is produced. The power takeoff connection 23 for the rear power takeoff 16, on the other hand, is oriented towards the rear and arranged centrically to the output shaft 10 at the end of the transmission 8.

Arranged in the front drive train 11, which has a drive shaft 24, an axle differential 25 and two axle shafts 26a, 26b for the front axle 12 in the direction of flow of the power, is a drive coupling 27 executed as a multi-plate clutch, by means of which the drive to the front axle 12 is capable of variable selection and control. In the present case, the drive coupling 27 is arranged, for example, close to the front power takeoff 15 of the output shaft 10 on the power takeoff casing 19, in that the bearing shaft of the external power takeoff wheel 21 is executed as a hollow shaft and is connected contrary to the direction of travel 28 to the input part of the drive coupling 27 positioned behind the power takeoff casing 19, and in that the output part of the drive coupling 27 is routed with an extended shaft through the hollow bearing shaft of the external power takeoff wheel 21 to the drive shaft 24.

The rear drive train 13, on the other hand, by means of which a permanent drive is provided to the rear axle 14, exhibits in the direction of flow of the power only a single drive shaft 29, an axle differential 30 and two axle shafts 31a, 31b for the rear axle 14.

For reasons of graphical representation, the output shaft 10 of the transmission 8 is depicted in FIG. 1 to FIG. 6 laterally adjacent to the input shaft 9, in conjunction with which the drive unit 4 in the illustrations is arranged displaced to the right and off-center in the direction of travel 28. In actual transmissions 8, however, the output shaft 10 is generally arranged displaced vertically or laterally beneath the input shaft 9, so that the drive unit 4 can be arranged essentially centrally, as a consequence of which an essentially balanced load distribution on the wheels of the front axle 12 is permitted.

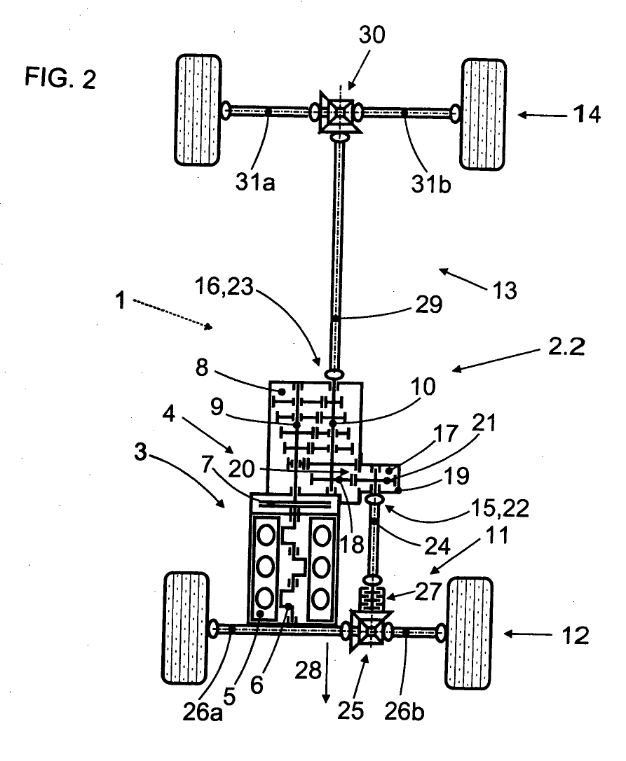

In a second embodiment in accordance with FIG. 2, the drive train 2.2 in accordance with the invention also exhibits permanent rear-wheel drive and engageable front-wheel drive. Unlike the embodiment in accordance with FIG. 1, the drive unit 4 as a whole is arranged displaced towards the rear contrary to the direction of travel 28 to a position behind the front axle 12 in order to achieve a shorter front overhang and/or a more favorable axle load distribution, and the drive coupling 27 is now arranged on the axle differential 25 of the front axle 12.

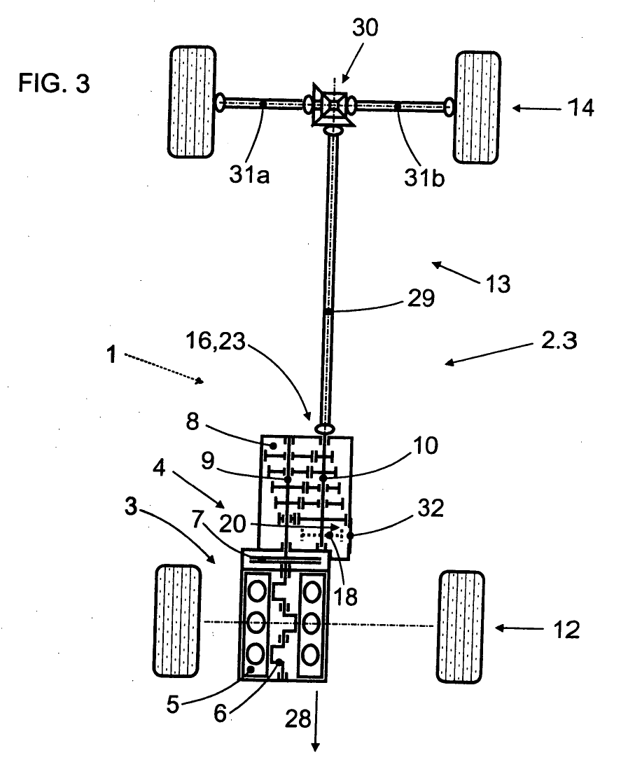

In a pure rear-wheel-drive embodiment of the drive train 2.3 in accordance with the invention as illustrated in FIG. 3, on the other hand, only the rear drive train 13 for the rear axle 14 with the drive shaft 29, the axle differential 30, and the two axle shafts 31a, 31b is present. The internal power takeoff wheel 18 of the front power takeoff 15 arranged on the output shaft 10 of the transmission 8 is without any function in this case, and can accordingly be economized in this embodiment. The opening 20 in the transmission 8 on the front power takeoff 15 from the output shaft 10 is closed with a cover 32.

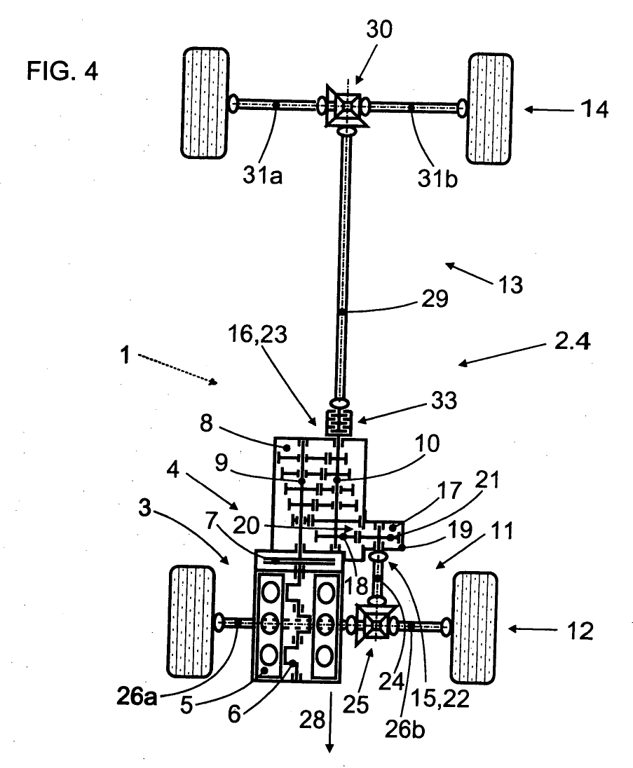

In a fourth embodiment in accordance with FIG. 4, the drive train 2.4 in accordance with the invention exhibits permanent front-wheel drive and engageable rear-wheel drive. Given the otherwise identical design and arrangement of the component parts as in the first embodiment in accordance with FIG. 1, the differences are that the front drive train 11 does not exhibit a drive coupling 27, but rather a permanent connection between the front power takeoff 15 from the output shaft 10 and the axle differential 25 of the front axle 12, and that the rear drive train 13 is now provided with a drive coupling 33 executed, for example, as a multi-plate clutch. The drive coupling 33 in the present case is arranged on the transmission 8 adjacent to the rear power takeoff 16 from the output shaft 10.

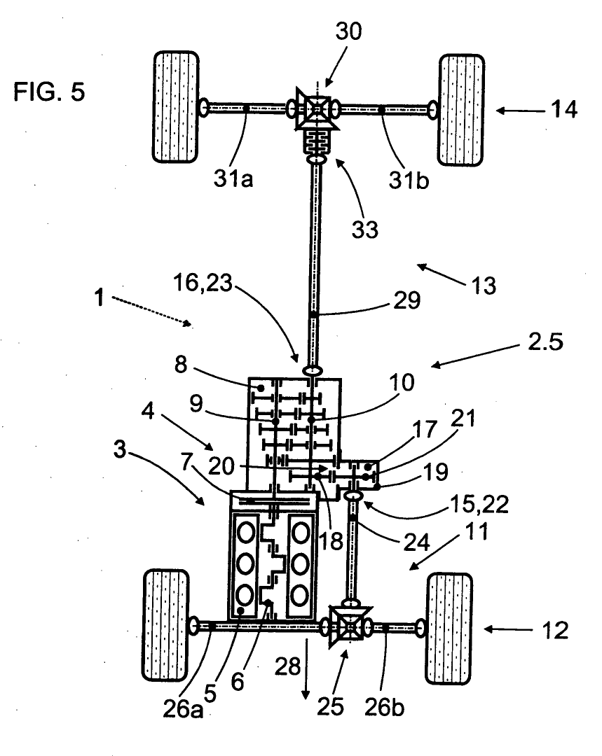

In a fifth embodiment in accordance with FIG. 5, the drive train 2.5 in accordance with the invention also exhibits permanent front-wheel drive and engageable rear-wheel drive. Unlike the embodiment in accordance with FIG. 4, the drive unit 4 as a whole is arranged displaced towards the rear contrary to the direction of travel 28 to a position behind the front axle 12 in order to achieve a shorter front overhang and/or a more favorable axle load distribution, and the drive coupling 33 is now arranged on the axle differential 30 of the rear axle 14.

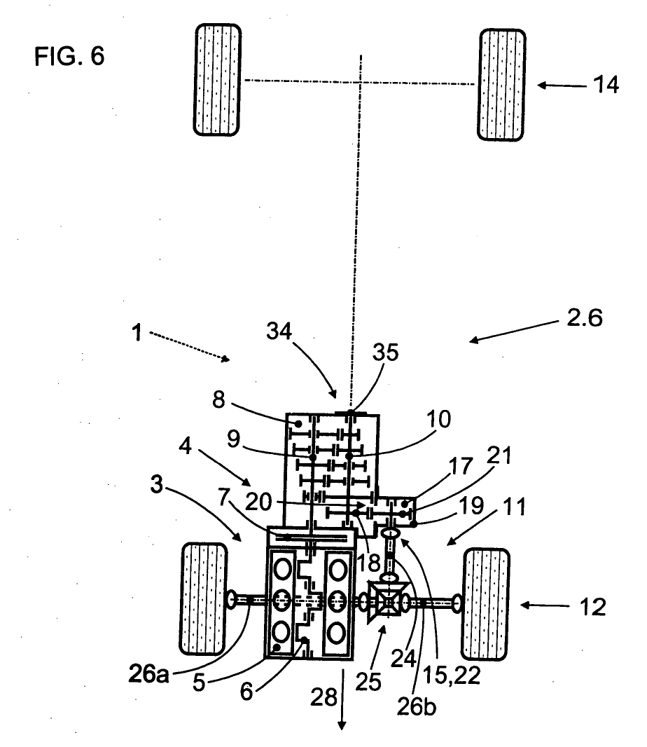

In a pure front-wheel-drive embodiment of the drive train 2.6 in accordance with the invention as illustrated in FIG. 6, on the other hand, only the front drive train 11 for the front axle 12 with the drive shaft 24, the axle differential 25, and the two axle shafts 26a, 26b is present. An opening 34 in the transmission 8 on the rear power takeoff 16 from the output shaft 10 is closed with a cover 35.

The drive train 2 in accordance with the invention is thus capable of application without restrictions on its construction in motor vehicles 1 with a drive unit 4 installed longitudinally at the front 3 of the vehicle, in conjunction with which the component parts of the drive train 2 constitute a modular system, from which drive trains 2 with all-wheel drive, rear-wheel drive and front-wheel drive can be assembled in a simple and space-saving manner without the need for significant modifications.

This application claims the priority, under 35 U.S.C. § 119, of German patent application DE 10 2005 029 112.0, filed Jun. 23, 2005; the prior application is herewith incorporated by reference in its entirety.

We claim:

1. A drive train for a motor vehicle having a front axle and a rear axle, comprising:
a drive unit disposed longitudinally at a front of the vehicle and including a driving engine and a transmission;
said transmission having an input shaft connectible to a drive shaft of said driving engine and an output shaft connected for selectively driving a rear drive train of the rear axle and/or a front drive train of the front axle;
said transmission having a front power takeoff disposed for connection of the front drive train to a front end of said output shaft and for connection of a power takeoff connection laterally adjacent said transmission and oriented forward towards the front, and said transmission having a rear power takeoff disposed for connection of the rear drive train to a rear end of said output shaft remote from the engine and for connection of a power takeoff connection lying centrically at an end of said transmission and oriented towards the rear.

2. The drive train according to claim 1, wherein said front power takeoff from the transmission is an output gearbox with an internal power takeoff wheel disposed within said transmission and mounted rigidly and non-rotatably on said output shaft, and an external power takeoff wheel outside said transmission mounted rotatably about an axis parallel to said output shaft in a power takeoff casing, said external power takeoff wheel projecting through an opening in said transmission and meshing with said inner power takeoff wheel.

3. The drive train according to claim 1, wherein the motor vehicle is configured for all-wheel drive propulsion with engageable front-wheel drive, and the rear axle is permanently connected via said rear drive train to said output shaft of said transmission, and the front axle is variably engageably connected via a controllable drive coupling disposed in said front drive train to said output shaft of said transmission.

4. The drive train according to claim 3, wherein said drive coupling is disposed in close proximity to said front power takeoff from said transmission.

5. The drive train according to claim 4, wherein said drive coupling is disposed in a power takeoff housing.

6. The drive train according to claim 3, wherein said drive coupling is disposed on an axle differential of the front axle.

7. The drive train according to claim 1, wherein the motor vehicle is configured for rear-wheel-drive propulsion with only the rear drive train permanently connected to said output shaft of said transmission, and an opening in said transmission at said front power takeoff is closed.

8. A drive train for a motor vehicle with rear-wheel drive, comprising:
a drive unit disposed longitudinally at a front of the vehicle and including a driving engine and a transmission;
said transmission having an input shaft connectible to a drive shaft of said driving engine and an output shaft connected for driving a rear drive train of the rear axle of the motor vehicle;
said transmission having a rear power takeoff connected between the rear drive train and a rear end of said output shaft remote from the engine and a power takeoff connection lying centrically at an end of said transmission and oriented towards the rear; and
said transmission being configured with a front power takeoff disposed for connection of a front drive train to a front end of said output shaft and having a closed opening at said front power takeoff.

9. The drive train according to claim 1, wherein the motor vehicle is configured for all-wheel-drive propulsion with engageable rear-wheel drive, and the front axle is permanently connected via the front drive train to said output shaft of said transmission, and the rear axle is variably engageably connected via a controllable drive coupling disposed in said rear drive train to said output shaft of said transmission.

10. The drive train according to claim 8, wherein said drive coupling is disposed in close proximity to said rear power takeoff on said transmission.

11. The drive train according to claim 8, wherein said drive coupling is disposed on an axle differential of said rear axle.

12. The drive train according to claim 1, wherein the motor vehicle is configured for front-wheel-drive propulsion with only the front drive train permanently connected to said output shaft of said transmission, and an opening in said transmission at said rear power takeoff is closed.

13. A drive train for a motor vehicle with front-wheel drive, comprising:
a drive unit disposed longitudinally at a front of the vehicle and including a driving engine and a transmission;
said transmission having an input shaft connectible to a drive shaft of said driving engine and an output shaft connected for driving a front drive train of a front axle of the motor vehicle;
said transmission having a front power takeoff disposed for connection of the front drive train to a front end of said output shaft and a power takeoff connection laterally adjacent said transmission and oriented forward towards the front; and
said transmission being configured for a rear power takeoff at a rear end of said output shaft remote from the engine and having a closed opening at said rear power takeoff.
